(19) United States
(12) Patent Application Publication
(10) Pub. No.: US 2023/0237501 A1
(43) Pub. Date: Jul. 27, 2023

(54) ONLINE WARRANTY UPDATING SYSTEM AND METHOD OF USING THE SAME

(71) Applicant: Dell Products, L.P., Round Rock, TX (US)

(72) Inventors: Vaideeswaran Ganesan, Bangalore (IN); Nidhi Kant Arora, Bangalore (IN); Chandrasekhar Revuri, Bangalore (IN)

(73) Assignee: Dell Products, L.P., Round Rock, TX (US)

(21) Appl. No.: 17/648,850

(22) Filed: Jan. 25, 2022

(51) Int. Cl. G06Q 30/00; G06F 21/44

(52) U.S. Cl. CPC G06Q 30/012; G06F 21/44

(57) ABSTRACT

Systems and methods provide a warranty updating system for transferal of an Information Handling System (IHS) from a first entity to a second entity. In some embodiments, the warranty updating system includes computer-executable instructions to receive a request to manage a warranty transfer of the IHS in which the first entity is separate and distinct from a vendor of the first IHS. The system may obtain an inventory of the first IHS. determine one or more recommended warranty options for the second entity based on the received inventory, and present the warranty options for consumption by the second entity. When the system receives a selected warranty option from the first entity, it may configure the first IHS for use by the second entity based upon the selected warranty option.

### BACKGROUND

Information Handling Systems (IHSs) process, compile, store, and/or communicate information or data for business, personal, or other. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs are typically sold with a standard warranty that provides for repair or replacement of the system if a component of the system fails during an initial warranty period. A particular model computer system may be sold in many different configurations. For example, the processor will be available in several different clock frequencies, memory is available in many different increments, the size of disk storage will vary, and different video and audio controllers may be employed. In other words, different IHSs will have different configurations due to the relatively large variation in configuration options for IHSs.

As the inventors hereof have determined, a warranty typically attaches to the system in the condition it leaves the factory, systems integrator or reseller. If a user makes changes to the configuration after sale, it is possible that the initial warranty may be void or will not cover the new configuration.

Moreover, as also recognized by the inventors, IHS customers often do make changes to the system configuration after sale. For example, a larger hard disk drive or a video card may be added by the user to increase the IHS’s performance. This presents a problem when the user approaches the seller asking for an upgraded warranty that covers the new configuration. Questions may also arise with respect to what the price of the upgraded warranty should be. A “one size fits all” upgraded warranty price where a single warranty price is quoted that is the same for all configurations of a particular model computer system even though the configurations often vary (e.g., the warranty price is based on the average of expected warranty costs spread across the many different configurations of a particular model) would be undesirable. It is with these problems in mind that embodiments of the systems and methods for online warranty updating are described herein.

### SUMMARY

Systems and methods provide a warranty updating system for transferal of an Information Handling System (IHS) from a first entity to a second entity. According to one embodiment, the warranty updating system includes computer-executable instructions to receive a request to manage a warranty transfer of the IHS in which the first entity is separate and distinct from a vendor of the first IHS. The system may obtain an inventory of the first HIS, determine one or more recommended warranty options for the second entity based on the received inventory, and present the warranty options for consumption by the second entity. When the system receives a selected warranty option from the first entity, it may configure the first IHS for use by the second entity based upon the selected warranty option.

According to another embodiment, an online warranty management method includes the steps of receiving a request to manage a warranty transfer of a first Information Handling System (IHS) from a first entity to a second entity, obtaining an inventory of the first IHS, and based on the received inventory, determining one or more recommended warranty options for the second entity. The method further includes the steps of presenting the warranty options for consumption by the second entity, receiving a selected warranty option from a first entity IHS associated with the first entity, and configuring the first IHS for use by the second entity based upon the selected warranty option.

According to yet another embodiment, a computer program product includes a computer readable storage medium that stores instructions, which when executed, cause a processor to receive a request to manage a warranty transfer of a first Information Handling System (IHS) from a first entity to a second entity, obtain an inventory of the first HIS, and based on the received inventory, determine one or more recommended warranty options for the second entity. The instructions also cause the processor to present the warranty options for consumption by the second entity, receive a selected warranty option from a first entity IHS associated with the first entity, and configure the first IHS for use by the second entity based upon the selected warranty option.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 illustrates an example online warranty updating system according to one embodiment of the present disclosure.

FIG. 2 is a block diagram illustrating components of example IHS that may be configured to update a warranty for another IHS according to one embodiment of the present disclosure.

FIG. 3 is a diagram showing how the example recommendation engine may be used to generate warranty recommendations according to one embodiment of the present disclosure.

FIG. 4 illustrates an example online warranty management method that may be performed to update a warranty for an IHS according to one embodiment of the present disclosure.

FIG. 5 illustrates an example online warranty unlocking method that may be performed in conjunction with the online warranty unlocking method of FIG. 4 to update a warranty for an IHS 106 according to one embodiment of the present disclosure.

### DETAILED DESCRIPTION

Embodiments of the present disclosure provide an online warranty updating system and method that may be used to accurately assess warranty costs during transfer of an Information Handling System (IHS), such as a sale of the IHS from a seller to a buyer. Whereas traditional warranty cost models for IHSs have traditionally involved a “one size fits all” approach, the resulting warranty price is often based on an average expected warranty cost spread across the many different configurations of a particular model. Embodiments of the present disclosure provide a solution to this problem, among other problems, by providing an online warranty updating system that accurately determines a warranty cost for users, particularly third party entities such as retailers who want to pass any currently remaining warranty protections to their buyers.

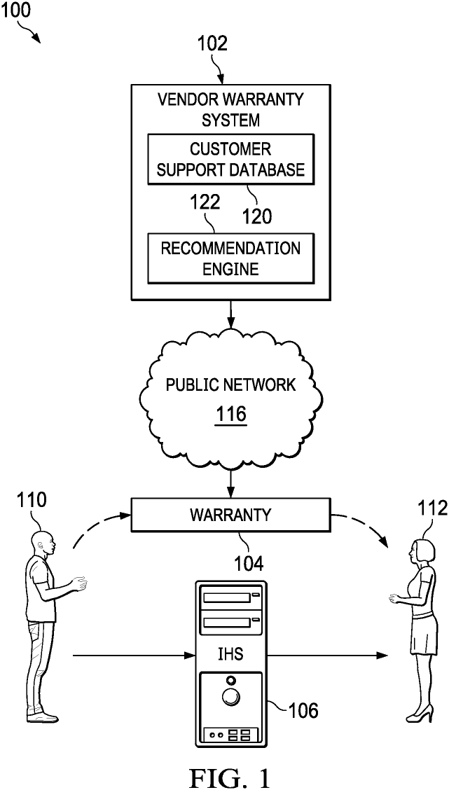

FIG. 1 illustrates an example online warranty updating system 100 according to one embodiment of the present disclosure. The online warranty updating system 100 includes a vendor warranty system 102 that tracks warranty terms and coverage (hereinafter “warranty”) 104 for an IHS 106. As shown, the online warranty updating system 100 may manage (e.g., update) the warranty 104 associated with the IHS 106 when it is sold from a seller 110 to a buyer 112. In other embodiments, it is contemplated that the warranty 104 may be managed at any suitable time, such as when the user of the IHS 106 adds, changes, or removes components (e.g., Field Replaceable Units (FRUs)) to or from the IHS 106. As will be described in detail herein below, the vendor warranty system 102 communicates with the seller 110, buyer 112, and IHS 106 to manage or update the warranty 104 either directly or through a public network 116, such as the Internet.

The vendor warranty system 102 tracks warranty terms and coverage for the IHS 106. For example, the vendor warranty system 102 may comprise a customer support database 120 and a recommendation engine 122. Customer support database 120 may store user account information, such as an account established with each of the seller 110 and the buyer 112. The customer support database 120 may also store warranty information, such as terms and conditions, Service Level Agreements (SLAs), and other customer warranty details that may be associated with the IHS 106. The recommendation engine 122 may be used to assess the condition of the current warranty as well as the condition of the IHS 106 to generate one or more recommended warranty conditions for the seller 110 or buyer 112.

Conventional warranty systems typically generate and manage standard warranties for IHSs, such as servers, home computers, and the like. A standard warranty includes a typical service coverage that is offered to customers by a vendor, such as a manufacturer, seller, re-seller, or subcontracted service agent, upon purchase of the individual device, such as a typical server warranty. In some cases, the vendor may offer an extended warranty if that option is available. The vendor may support many types of warranties, which can make it difficult for a customer representative to select the correct warranty type applicable for the customer product. For larger customer accounts, the vendor may allocate a dedicated Technical Account Manager (TAM), who can analyze the customer requirements and help the customers with required warranty types. Unfortunately, customers may experience extended system downtime or degraded functionality when a non-optimal warranty has been purchased for the device. There are multiple reasons that contribute to the selection of a non-optimal warranty, such as limited understanding of cost or available warranty offerings, or changes in device usage or intent after purchase.

Warranties typically have common features, such as a warranty type that identifies the covered component types (e.g., software and/or hardware), a warranty replacement SLA that identifies the level of services expected by the customer from the vendor (e.g., next business day (NBD), second business day (SBD), four hours (4H), eight hours (8H), mission critical (MC), etc.), and a support type that identifies the types of support provided (e.g., engineer/technician level one (L1), level two (L2), or level three (L3), Post Support, etc.) or other support based on standard naming conventions. The warranty may also identify a warranty start date and a warranty end date. The warranty SLA can have a significant impact on the customer’s operations. For example, a server with a SBD warranty may experience downtime up to two days, which could have been reduced to four hours if a 4H response warranty was in place.

Gaps in warranty offers can exist. For example, while some of warranty offers may have three warranty types (e.g., L1, L1 +L2, L1 +L2+L3), in other warranties only L1 or L1+L2 might be offered. Moreover, in some cases a warranty offers coverage for products such as system management software; however, other warranty offers may not provide such coverage. At times, there may be a high volume of requests for support or part replacement that is not usually covered by warranty offers. If the volume of such requests increases, then the vendor may need to offer warranties with appropriate coverage, which would increase warranty revenue and increase customer confidence.

Certain scenarios can create negative customer experiences if the wrong warranty is in place. For example, a server’s performance may be degraded for an extended time due to redundant part failures, such as failure of one drive in a Redundant Array of Independent Disks (RAID) virtual disk. A server may experience extended downtime due to the time required to replace a failed critical part, such as a CPU, memory, backplane, or system board failure. A server may have to function with an extended risk due to redundant part failures, such as a power supply unit (PSU) or fan failure. Lack of customer awareness of warranty coverage may also cause customer dissatisfaction. For example, if a customer is not aware that a certain failure is within warranty support, then the customer will never report the issue and may instead request part replacement, which may result in unnecessary downtime and cost that could have been avoided.

Currently, after purchasing an asset (e.g., IHS) from a hardware vendor or reseller, a buyer may desire to change (e.g., upgrade) its configuration, such as the Operating System (OS), and other software elements. For a customer who wants to upgrade, many IHS vendors only offer software upgrade options with an old, initial warranty that was provided when the IHS was originally purchased. The buyer has not been conventionally provided with an opportunity to reassess any warranty needs that would otherwise be aligned with a new updated software stack (e.g., OS, component firmware, user applications, etc.).

Due to the lack of any upgraded warranty, therefore, IHS resellers are often required to sell their products with old software stacks making it a non-appealing option. For example, when a new OS (e.g., Windows, ESXi, Linux, etc.) version is released, customers purchasing refurbished systems being resold, would feel disadvantaged in buying IHS systems with an old OS. If those systems are repurposed with a new OS and new updated warranty options, it may become a lucrative business opportunity. This aspect may be particularly important given that some newer OS offerings have features requiring new warranty options. That is, if resellers were able to upgrade the software stack and the warranty options within vendor limits while reselling, it may become a lucrative business option. Given a particular example, a customer might be interested in upgrading an IHS with the latest compatible OS when purchasing a used IHS from a reseller. The customer might also be interested in upgrading component firmware and tools to their latest versions while purchasing the IHS and be provided with a warranty option that is optimally suited to the updated software.

For security purposes, any certificates and/or security keys used by the reseller should be transferred to the buyer without causing any security breach. Additionally, when customers resell their assets to others, they often do not fully format the disks, thus leaving them vulnerable to data exploitation. Securely erasing and fully formatting the drive enables the seller to ensure that no trace of the data of the original customer is leaked to the new owner (e.g., buyer). After securely erasing the seller’s data, the IHS still needs to be reloaded with the same software stack, or with a new upgraded software stack, thus engendering further warranty needs.

Given the facts presented above, it would be beneficial to provide an option of securely preparing the hardware, upgrading the software stack, evaluating any new warranty needs, followed by transferring ownership of the asset to the buyer. During the transfer, the outstanding warranty (e.g., the remaining portion of the warranty period) may be reassessed, and an upgraded warranty can be transferred to the new owner. As will be described in detail herein below, certain embodiments of the online warranty updating system provide a technique for preparing a hardware and software stack as per buyer needs by upgrading required firmware and software securely, thus enabling extended warranties and transferring the asset’s ownership for further usage of those warranties.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

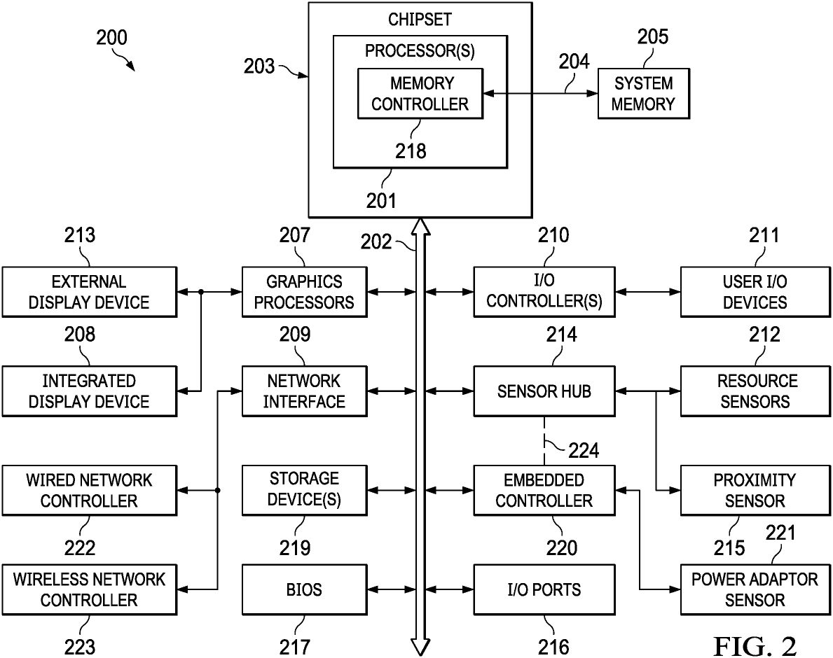

FIG. 2 is a block diagram illustrating components of example IHS 200 that may be configured to update a warranty for another IHS according to one embodiment of the present disclosure. IHS 200 may be implemented in whole, or as a part of client IHS 106, or vendor warranty system 102. As shown, IHS 200 includes one or more processors 201, such as a Central Processing Unit (CPU), that execute code retrieved from system memory 205. Although IHS 200 is illustrated with a single processor 201, other embodiments may include two or more processors, that may each be configured identically, or to provide specialized processing operations. Processor 201 may include any processor capable of executing program instructions, such as an Intel Pentium™ series processor or any general-purpose or embedded processors implementing any of a variety of Instruction Set Architectures (ISAs), such as the x86, POWERPC^{®}, ARM^{®}, SPARC^{®}, or MIPS^{®} ISAs, or any other suitable ISA.

In the embodiment of FIG. 2, processor 201 includes an integrated memory controller 218 that may be implemented directly within the circuitry of processor 201, or memory controller 218 may be a separate integrated circuit that is located on the same die as processor 201. Memory controller 218 may be configured to manage the transfer of data to and from the system memory 205 of IHS 200 via high-speed memory interface 204. System memory 205 that is coupled to processor 201 provides processor 201 with a high-speed memory that may be used in the execution of computer program instructions by processor 201.

Accordingly, system memory 205 may include memory components, such as static RAM (SRAM), dynamic RAM (DRAM), and/or NAND Flash memory, suitable for supporting high-speed memory operations by the processor 201. In certain embodiments, system memory 205 may combine both persistent, non-volatile memory and volatile memory. In certain embodiments, system memory 205 may include multiple removable memory modules.

IHS 200 utilizes chipset 203 that may include one or more integrated circuits that are coupled to processor 201. In the embodiment of FIG. 2, processor 201 is depicted as a component of chipset 203. In other embodiments, all of chipset 203, or portions of chipset 203 may be implemented directly within the integrated circuitry of the processor 201. Chipset 203 provides processor(s) 201 with access to a variety of resources accessible via bus 202. In IHS 200, bus 202 is illustrated as a single element. Various embodiments may utilize any number of separate buses to provide the illustrated pathways served by bus 202.

In various embodiments, IHS 200 may include one or more I/O ports 216 that may support removable couplings with various types of external devices and systems, including removable couplings with peripheral devices that may be configured for operation by a particular user of IHS 200. For instance, I/O ports 216 may include USB (Universal Serial Bus) ports, by which a variety of external devices may be coupled to IHS 200. In addition to or instead of USB ports, I/O ports 216 may include various types of physical I/O ports that are accessible to a user via the enclosure of the IHS 200.

In certain embodiments, chipset 203 may additionally utilize one or more I/O controllers 210 that may each support the operation of hardware components such as user I/O devices 211 that may include peripheral components that are physically coupled to I/O port 216 and/or peripheral components that are wirelessly coupled to IHS 200 via network interface 209. In various implementations, I/O controller 210 may support the operation of one or more user I/O devices 211 such as a keyboard, mouse, touchpad, touchscreen, microphone, speakers, camera and other input and output devices that may be coupled to IHS 200. User I/O devices 211 may interface with an I/O controller 210 through wired or wireless couplings supported by IHS 200. In some cases, I/O controllers 210 may support configurable operation of supported peripheral devices, such as user I/O devices 211.

As illustrated, a variety of additional resources may be coupled to the processor(s) 201 of the IHS 200 through the chipset 203. For instance, chipset 203 may be coupled to network interface 209 that may support different types of network connectivity. IHS 200 may also include one or more Network Interface Controllers (NICs) 222 and 223, each of which may implement the hardware required for communicating via a specific networking technology, such as Wi-Fi, BLUETOOTH, Ethernet and mobile cellular networks (e.g., CDMA, TDMA, LTE). Network interface 209 may support network connections by wired network controllers 222 and wireless network controllers 223. Each network controller 222 and 223 may be coupled via various buses to chipset 203 to support different types of network connectivity, such as the network connectivity utilized by IHS 200.

Chipset 203 may also provide access to one or more display device(s) 208 and 213 via graphics processor 207. Graphics processor 207 may be included within a video card, graphics card or within an embedded controller installed within IHS 200. Additionally, or alternatively, graphics processor 207 may be integrated within processor 201, such as a component of a system-on-chip (SoC). Graphics processor 207 may generate display information and provide the generated information to one or more display device(s) 208 and 213, coupled to IHS 200.

One or more display devices 208 and 213 coupled to IHS 200 may utilize LCD, LED, OLED, or other display technologies. Each display device 208 and 213 may be capable of receiving touch inputs such as via a touch controller that may be an embedded component of the display device 208 and 213 or graphics processor 207, or it may be a separate component of IHS 200 accessed via bus 202. In some cases, power to graphics processor 207, integrated display device 208 and/or external display device 213 may be turned off, or configured to operate at minimal power levels, in response to IHS 200 entering a low-power state (e.g., standby).

As illustrated, IHS 200 may support an integrated display device 208, such as a display integrated into a laptop, tablet, 2-in-1 convertible device, or mobile device. IHS 200 may also support use of one or more external display devices 213, such as external monitors that may be coupled to IHS 200 via various types of couplings, such as by connecting a cable from the external display device 213 to external I/O port 216 of the IHS 200. In certain scenarios, the operation of integrated display devices 208 and external display devices 213 may be configured for a particular user. For instance, a particular user may prefer specific brightness settings that may vary the display brightness based on time of day and ambient lighting conditions.

Chipset 203 also provides processor 201 with access to one or more storage devices 219. In various embodiments, storage device 219 may be integral to IHS 200 or may be external to IHS 200. In certain embodiments, storage device 219 may be accessed via a storage controller that may be an integrated component of the storage device. Storage device 219 may be implemented using any memory technology allowing IHS 200 to store and retrieve data. For instance, storage device 219 may be a magnetic hard disk storage drive or a solid-state storage drive. In certain embodiments, storage device 219 may be a system of storage devices, such as a cloud system or enterprise data management system that is accessible via network interface 209.

As illustrated, IHS 200 also includes a Basic Input/Output System (BIOS) 217 that may be stored in a non-volatile memory accessible by chipset 203 via bus 202. Upon powering on or restarting IHS 200, processor(s) 201 may utilize BIOS 217 instructions to initialize and test hardware components coupled to the IHS 200. BIOS 217 instructions may also load an operating system (OS) (e.g., WINDOWS, MACOS, iOS, ANDROID, LINUX, etc.) for use by IHS 200.

BIOS 217 provides an abstraction layer that allows the operating system to interface with the hardware components of the IHS 200. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

As illustrated, certain IHS 200 embodiments may utilize sensor hub 214 capable of sampling and/or collecting data from a variety of sensors. For instance, sensor hub 214 may utilize hardware resource sensor(s) 212, which may include electrical current or voltage sensors, which are capable of determining the power consumption of various components of IHS 200 (e.g., CPU 201, GPU 207, system memory 205, etc.). In certain embodiments, sensor hub 214 may also include capabilities for determining a location and movement of IHS 200 based on triangulation of network signal information and/or based on information accessible via the OS or a location subsystem, such as a GPS module.

In some embodiments, sensor hub 214 may support proximity sensor(s) 215, including optical, infrared, and/or sonar sensors, which may be configured to provide an indication of a user’s presence near IHS 200, absence from IHS 200, and/or distance from IHS 200 (e.g., near-field, mid-field, or far-field).

In certain embodiments, sensor hub 214 may be an independent microcontroller or other logic unit that is coupled to the motherboard of IHS 200. Sensor hub 214 may be a component of an integrated system-on-chip incorporated into processor 201, and it may communicate with chipset 203 via a bus connection such as an Inter-Integrated Circuit (l²C) bus or other suitable type of bus connection. Sensor hub 214 may also utilize an 1²C bus for communicating with various sensors supported by IHS 200.

As illustrated, IHS 200 may utilize embedded controller (EC) 220, which may be a motherboard component of IHS 200 and may include one or more logic units. In certain embodiments, EC 220 may operate from a separate power plane from the main processors 201 and thus the OS operations of IHS 200. Firmware instructions utilized by EC 220 may be used to operate a secure execution system that may include operations for providing various core functions of IHS 200, such as power management, management of operating modes in which IHS 200 may be physically configured and support for certain integrated I/O functions.

EC 220 may also implement operations for interfacing with power adapter sensor 221 in managing power for IHS 200. These operations may be utilized to determine the power status of IHS 200, such as whether IHS 200 is operating from battery power or is plugged into an AC power source (e.g., whether the IHS is operating in AC-only mode, DC-only mode, or AC + DC mode). In some embodiments, EC 220 and sensor hub 214 may communicate via an out-of-band signaling pathway or bus 224.

In various embodiments, IHS 200 may not include each of the components shown in FIG. 2. Additionally, or alternatively, IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 201 as an SoC.

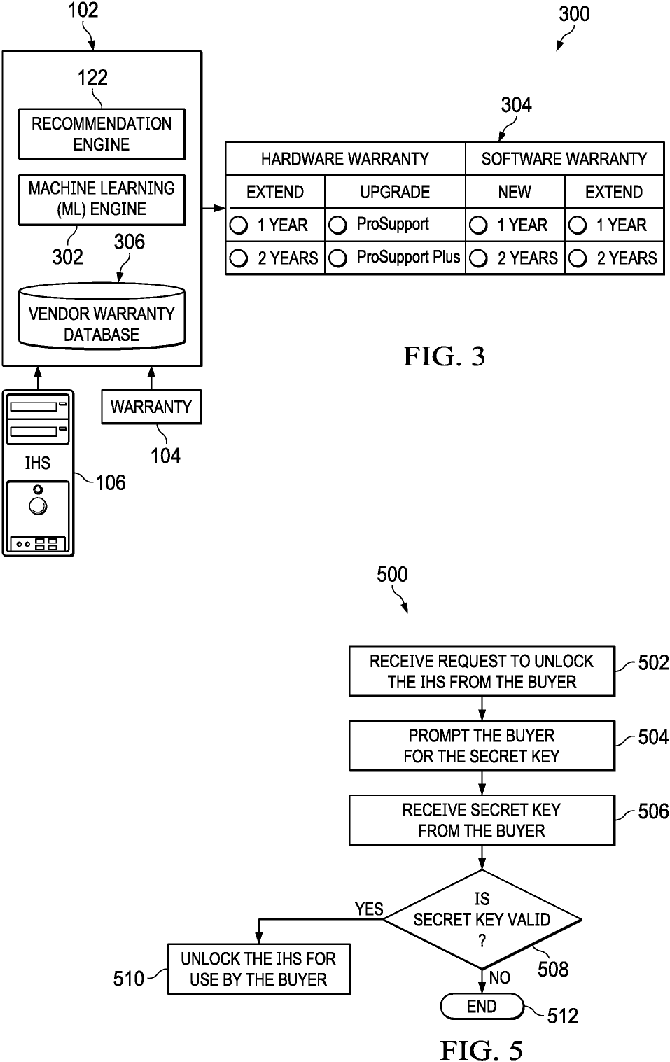

FIG. 3 is a diagram showing how the example recommendation engine 122 may be used to generate warranty recommendations according to one embodiment of the present disclosure. The vendor warranty system 102 includes a recommendation engine 122, a Machine Learning (ML) engine 302, and a vendor warranty database 306 for storing warranty information about IHS 106.

In general, the recommendation engine 122 receives IHS information from the IHS 106, and warranty information associated with the IHS 106 to generate one or more recommendations 304 for the seller 110 or buyer 112. For example, if the buyer 112 is purchasing the IHS 106, the recommendations will be generated for the buyer 112. In other scenarios, if the seller 110 is preparing the IHS 106 to be sold at a later point in time or for other reasons (e.g., upgrading the warranty status, etc.), the recommendations will be generated for the seller 110. Given a particular example, the recommendation engine 122 may, during an active login session via an account of the user (e.g., seller or buyer), access the warranty information associated with the IHS 106, access the IHS 106 to obtain its inventory of components including Field Replaceable Units (FRUs), to generate one or more warranty recommendations for the user.

In one embodiment, the recommendation engine 122 generates the warranty recommendations using a Machine Learning (ML) engine 302. In general, the ML engine 302 performs a machine learning process to derive certain warranty-based features associated with the IHS 100. The ML engine 302 obtains characteristics of the IHS 106 (e.g., quantity and type of components, amount of memory, processor type, available peripheral devices, age of the IHS 106, etc.) along with the characteristics of its associated warranty (e.g., existing SLA agreement, types of support levels provided, etc.) to characterize the current warranty coverage. Once the ML engine 302 has collected a sufficient amount of data, it may then process the collected data using statistical descriptors to extract the warranty-based features of the IHS 106. The ML engine 302 may use any suitable machine learning algorithm such as, for example, a Bayesian algorithm, a Linear Regression algorithm, a Decision Tree algorithm, a Random Forest algorithm, a Neural Network algorithm, or the like. The ML engine 302 may then evaluate the warranty-based features to generate a trained ML model to obtain one or more warranty recommendations 304. The recommendation engine 122 obtains the warranty recommendations and displays them on a display, such as on an IHS 106 managed by the user. For example, the recommendation engine 122 may be executed on an IHS 106 configured in the vendor warranty system 102, which communicates with the IHS 106 through the network 116 to generate the warranty recommendations 304 that are displayed for consumption by the user.

The recommendation engine 122 may obtain the IHS information in any suitable manner. In one embodiment, the IHS 106 may obtain the IHS information from a baseboard management controller (BMC) (e.g., remote access controller or chassis management controller). The BMC allows information technology (IT) administrators to deploy, update, monitor, and maintain the IHS 106 remotely. As a non-limiting example of a remote access controller, the integrated Dell Remote Access Controller (iDRAC) from Dell® is embedded within Dell PowerEdge™ servers and provides such remote functionality. The recommendation engine 122 may communicate with the baseboard management controller to obtain the IHS information (e.g., IHS inventory).

In another embodiment, the recommendation engine 122 may obtain the IHS information from the firmware of the IHS 106, such as BIOS 217. The firmware may include hardware device data that is used to store information associated with certain hardware devices (e.g., processor(s) 201, system memory 205, wired network controller 222, wireless network controller 223, graphics processors 207, I/O ports 216, etc.). The system memory 205 of the IHS 106 may also include a UEFI interface and/or a SMBIOS interface for accessing the BIOS 217 as well as updating the BIOS 217. In general, the UEFI interface provides a software interface between an operating system and BIOS 217 that may be used for conveying the inventory information to the recommendation engine 122. In many cases, the UEFI interface can support remote diagnostics and repair of computers, even with no operating system installed. SMBIOS interface can be used to read management information produced by the BIOS 217 of the IHS 106. This feature can eliminate the need for the operating system to probe hardware directly to discover what devices are present in the computer. Such a technique may be useful in scenarios where the IHS 106 has no onboard baseboard management controller.

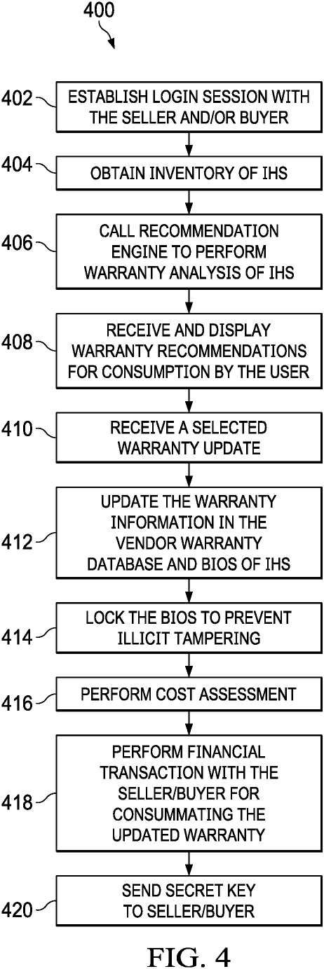

FIG. 4 illustrates an example online warranty management method 400 that may be performed to update a warranty for an IHS 106 according to one embodiment of the present disclosure. The method 400 may be performed in whole, or at least in part, by the vendor warranty system 102 that communicates with an IHS, such as IHS 106 whose warranty is to be updated. Initially, an account is established for the seller 110 and the buyer 112 from which login sessions may be established.

Initially at step 402, the method 400 establishes login session(s) with the seller and/or buyer. For example, the method 400 may establish a login session with the buyer 112 when they are purchasing the IHS 106 from the seller. Alternatively, the method 400 may establish a login session with the seller 110 when they are updating the warranty of the IHS 106, such as when the IHS 106 is to be sold at a later point in time, or for upgrading the warranty status, and the like. Thereafter at step 404, the method 400 obtains an inventory of the IHS 106. In one embodiment, the method 400 may obtain the inventory by accessing the inventory information from a BMC configured in the IHS 106. In another embodiment, the method 400 may obtain the inventory via accessing the BIOS 217 of the IHS 106, such as by accessing a UEFI interface and/or a SMBIOS interface of the BIOS 217.

At step 406, the method 400 calls the recommendation engine 122 to perform warranty analysis of the IHS 106. For example, the recommendation engine 122 may perform a ML process that uses the IHS inventory information and current warranty information to generate one or more optional warranty offers to the user (e.g., buyer or seller). The method 400 then receives and displays warranty recommendations for consumption by the user at step 408. When the user makes a selection of a desired warranty offering, the method 400 receives a selected warranty update at step 410. Thereafter at step 412, the method 400 updates the warranty information in the vendor warranty database 306 and the IHS 106 (e.g., BIOS and/or BMC).

At step 414, the method 400 locks the BIOS of the IHS 106. For example, the method 400 may lock the BIOS to prevent illicit tampering by either the buyer or seller. For example, if the BIOS was not locked, additional FRUs may be illicitly configured on the IHS 106 that would not be covered under warranty protection. Thus, the seller 110 could indiscriminately add illicit warranty protection by merely replacing certain FRUs each time the warranty is updated. Thus by locking the BIOS of the IHS 106, only the FRUs that were used to obtain the updated warranty could be used in the operation of the IHS 106. In one embodiment, locking of the BIOS may include preventing any Operating System from being started (e.g., booted). In another embodiment, locking of the BIOS may include disabling certain features of the IHS 106.

At step 416, the method 400 performs a cost assessment for the updated warranty. That is, the method 400 determines a monetary cost to be assessed to the user for updating the warranty to its selected type. The method 400 then performs a financial transaction with the user for consummating the updated warranty at step 418. For example, the method 400 may obtain financial information (e.g., credit card information, bank account information, etc.) from the user and communicate with a server associated with the financial account for paying for the updated warranty. Thereafter at step 420, the method 400 transmits a secret key to the user. The use and purpose of the secret key will be described in detail herein below.

FIG. 5 illustrates an example online warranty unlocking method 500 that may be performed in conjunction with the online warranty unlocking method 400 of FIG. 4 to update a warranty for an IHS 106 according to one embodiment of the present disclosure. The method 400 may be performed in whole, or at least in part, by the BIOS 217 and/or BMC configured in the IHS 106. Initially, the method 400 of FIG. 4 is performed to update the warranty and generate a secret key for use by the buyer. For example, the method 400 of FIG. 4 may be performed when the buyer 112 purchases or otherwise procures the IHS 106 from the seller 110, while the method 500 of FIG. 5 may be performed when the buyer 112 initially starts the purchased (procured) IHS 106 for the first time. In other embodiments, the method 500 of FIG. 5 may be performed by any suitable entity, such as the seller 110 following an update of the warranty on the IHS 106 using method 400.

At step 502, the method 500 receives, from the buyer, a request to unlock the IHS. For example, the buyer may issue the request following acquisition of the IHS 106 from the seller 110. Thereafter at step 504, the method 500 prompts the buyer for the secret key. For example, the secret key may be a passcode or password generated by the method 500 at step 420. The method 500 then receives the secret key from the buyer at step 506. If the secret key is valid, processing continues at step 510; otherwise, processing continues at step 512 in which the process ends in which the IHS 106 remains locked. At step 510, the method 500 unlocks the IHS for use by the buyer. For example, the method 500 may unlock the IHS 106 by enabling an Operating System to be started (e.g., booted), and/or enabling any features that have been previously disabled due to the locking procedure. Nevertheless, the method 500 ends at step 512.

Although FIGS. 4 and 5 describes example methods that may be performed to update a warranty for an IHS 106 using an online process, the features of the disclosed process may be embodied in other specific forms without deviating from the spirit and scope of the present disclosure. For example, the methods 400 and 500 may perform additional, fewer, or different operations than those operations as described in the present example. For example, certain steps of the methods 400 and 500 may be performed in a sequence different from that described above. As another example, certain steps of the aforedescribed processes may be performed by systems other than the vendor warranty system 102 and/or IHS 106 as described herein above.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. An online warranty updating system comprising:
at least one processor; and
at least one memory having program instructions stored thereon that, upon execution by at least one processor, cause the system to:
receive a request to manage a warranty transfer of a first Information Handling System (IHS) from a first entity to a second entity, wherein the first entity is separate and distinct from a vendor of the first IHS;
obtain an inventory of the first IHS;
based on the received inventory, determine one or more recommended warranty options for the second entity;
present the warranty options for consumption by the second entity;
receive a selected warranty option from a first entity IHS associated with the first entity; and
configure the first IHS for use by the second entity based upon the selected warranty option.

2. The online warranty updating system of claim 1, wherein the first entity comprises a seller of the IHS and the second entity comprises a buyer of the IHS.

3. The online warranty updating system of claim 1, wherein the instructions, upon execution, further cause the controller to lock the first IHS when the first IHS is configured for use by the second entity.

4. The online warranty updating system of claim 3, wherein the instructions, upon execution, further cause the controller to generate a secret key, and provide the secret key to the second entity, and unlock the IHS for use by the second entity when the secret key is entered by the second entity.

5. The online warranty updating system of claim 4, wherein the instructions, upon execution, further cause the controller to receive the secret key using an account login session associated with the second entity.

6. The online warranty updating system of claim 3, wherein the instructions, upon execution, further cause the controller to lock the first IHS by at least one of inhibition of execution of an Operating System (OS) of the IHS, or disablement of certain features of the IHS.

7. The online warranty updating system of claim 1, wherein the instructions, upon execution, further cause the controller to receive the request to manage the warranty transfer using an account login session associated with the first entity.

8. The online warranty updating system of claim 1, wherein the instructions, upon execution, further cause the controller to obtain the inventory of the IHS using a baseboard management controller (BMC) configured in the IHS.

9. The online warranty updating system of claim 1, wherein the instructions, upon execution, further cause the controller to obtain the inventory of the IHS using a Basic Input Output System (BIOS) of the IHS.

10. The online warranty updating system of claim 1, wherein the instructions, upon execution, further cause the system to: receive the request to manage the warranty transfer, obtain the inventory of the first IHS, determine the recommended warranty options, present the warranty options for consumption by the second entity, receive the selected warranty option from the first entity IHS associated with the first entity, and configure the first IHS for use using an online account management process.

11. An online warranty management method comprising:
receiving a request to manage a warranty transfer of a first Information Handling System (IHS) from a first entity to a second entity, wherein the first entity is separate and distinct from a vendor of the first IHS;
obtaining an inventory of the first IHS;
based on the received inventory, determining one or more recommended warranty options for the second entity;
presenting the warranty options for consumption by the second entity;
receiving a selected warranty option from a first entity IHS associated with the first entity; and
configuring the first IHS for use by the second entity based upon the selected warranty option.

12. The online warranty management method of claim 11, further comprising locking the first IHS when the first IHS is configured for use by the second entity.

13. The online warranty management method of claim 12, further comprising generating a secret key, providing the secret key to the second entity, and unlocking the IHS for use by the second entity when the secret key is entered by the second entity.

14. The online warranty management method of claim 13, further comprising receiving the secret key using an account login session associated with the second entity.

15. The online warranty management method of claim 13, further comprising locking the first IHS by at least one of: inhibiting execution of an Operating System (OS) of the IHS, or disabling certain features of the IHS.

16. The online warranty management method of claim 11, further comprising receiving the request to manage the warranty transfer using an account login session associated with the first entity.

17. The online warranty management method of claim 11, further comprising obtaining the inventory of the IHS using a baseboard management controller (BMC) configured in the IHS.

18. The online warranty management method of claim 11, further comprising obtaining the inventory of the IHS using a Basic Input Output System (BIOS) of the IHS.

19. The online warranty management method of claim 11, further comprising receiving the request to manage the warranty transfer, obtaining the inventory of the first IHS, determining the recommended warranty options, presenting the warranty options for consumption by the second entity, receiving the selected warranty option from the first entity IHS associated with the first entity, and configuring the first IHS for use using an online account management process.

20. A computer program product comprising a computer readable storage medium having program instructions embodied therewith, the program instructions executable by a processor to cause the processor to:
receive a request to manage a warranty transfer of a first Information Handling System (IHS) from a first entity to a second entity, wherein the first entity is separate and distinct from a vendor of the first IHS;
obtain an inventory of the first IHS;
based on the received inventory, determine one or more recommended warranty options for the second entity;
present the warranty options for consumption by the second entity;
receive a selected warranty option from a first entity IHS associated with the first entity; and
configure the first IHS for use by the second entity based upon the selected warranty option.
